(19) United States
(12) Patent Application Publication
(10) Pub. No.: US 2016/0064807 A1
(43) Pub. Date: Mar. 3, 2016

(54) Multiband Vehicular Antenna Assemblies

(71) Applicant: Laird Technologies, Inc., Earth City, MO (US)

(72) Inventors: Gary Keith Reed, Grand Blanc, MI (US); Thomas Shirley, Chesaning, MI (US)

(21) Appl. No.: 14/501,568

(22) Filed: Sep. 30, 2014

Related U.S. Application Data
(60) Provisional application No. 62/043,433, filed on Aug. 29, 2014.

(51) Int. Cl. H01Q 1/32; H01Q 5/20; H01Q 5/321

(52) U.S. Cl. CPC H01Q 1/3275; H01Q 5/321; H01Q 5/20

(57) ABSTRACT

Disclosed are exemplary embodiments of multiband vehicular antenna assemblies. In an exemplary embodiment, an antenna assembly for installation to a vehicle body wall is disclosed. The antenna assembly generally includes an antenna comprising electrical conductors along first and second sides of the first antenna that are interconnected to thereby define an electrical path extending around at least part of the antenna. The antenna is configured to be operable within multiple frequency bands including at least a first frequency band, a second frequency band higher than the first frequency band, and a third frequency band higher than the second frequency band. For example, an exemplary embodiment includes an antenna operable within multiple frequency bands including AM (amplitude modulation), FM (frequency modulation), and DAB-III (digital audio broadcasting) frequency bands.

### CROSS-REFERENCE TO RELATED APPLICATION

This application claims the benefit of and priority to U.S. Provisional Application No. 62/043,433 filed Aug. 29, 2014. The entire disclosure of the above application is incorporated herein by reference.

### FIELD

The present disclosure generally relates to multiband vehicular antenna assemblies.

### BACKGROUND

This section provides background information related to the present disclosure which is not necessarily prior art.

Different types of antennas are used in the automotive industry, including AM/FM radio antennas, satellite digital audio radio service antenna (SDARS), cellular phone antennas, satellite navigation antennas, etc. Multiband antenna assemblies are also commonly used in the automotive industry. A multiband antenna assembly typically includes multiple antennas to cover and operate at multiple frequency ranges. A printed circuit board (PCB) having radiating antenna elements is a typical component of the multiband antenna assembly.

Automotive antennas may be installed or mounted on a vehicle surface, such as the roof, trunk, or hood of the vehicle to help ensure that the antennas have unobstructed views overhead or toward the zenith. The antenna may be connected (e.g., via a coaxial cable, etc.) to one or more electronic devices (e.g., a radio receiver, a touchscreen display, navigation device, cellular phone, etc.) inside the passenger compartment of the vehicle, such that the multiband antenna assembly is operable for transmitting and/or receiving signals to/from the electronic device(s) inside the vehicle.

### SUMMARY

This section provides a general summary of the disclosure, and is not a comprehensive disclosure of its full scope or all of its features.

According to various aspects, exemplary embodiments are disclosed of multiband vehicular antenna assemblies. In an exemplary embodiment, an antenna assembly for installation to a vehicle body wall is disclosed. The antenna assembly generally includes an antenna comprising electrical conductors along first and second sides of the first antenna that are interconnected to thereby define an electrical path extending around at least part of the antenna. The antenna is configured to be operable within multiple frequency bands including at least a first frequency band, a second frequency band higher than the first frequency band, and a third frequency band higher than the second frequency band. For example, an exemplary embodiment includes an antenna operable within multiple frequency bands including AM (amplitude modulation), FM (frequency modulation), and DAB-III (digital audio broadcasting) frequency bands.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an example embodiment of an antenna assembly including at least one or more aspects of the present disclosure;

FIG. 2 is another perspective view of the antenna assembly shown in FIG. 1;

FIG. 3 is a perspective view of the opposite side of the antenna assembly shown in FIG. 2;

FIG. 4 is an exploded perspective view of the antenna assembly shown in FIG. 2, and also showing an examples of a cover or radome and an electrically-conductive insert according to exemplary embodiments;

FIG. 5 is an exploded perspective view showing the opposite of the antenna assembly shown in FIG. 4;

FIG. 6 is a perspective view of the AM/FM/DAB antenna shown in FIGS. 1 through 5 and illustrating a first side of the printed circuit board (PCB) having electrically-conductive traces and an inductor and capacitor thereon for shorting out a portion of the electrically-conductive traces at DAB-III frequencies according to exemplary embodiments;

FIG. 7 is a perspective view of the AM/FM/DAB antenna shown in FIG. 6 and illustrating a second side of the printed circuit board (PCB) having electrically-conductive traces thereon according to exemplary embodiments;

FIG. 8 is a lower perspective view of the antenna assembly shown in FIG. 1 after the cover or radome shown in FIG. 4 has been installed;

FIG. 9 is a lower perspective view showing exemplary communication links and electrical connectors for coupling the antenna assembly shown in FIG. 1 to electronic devices within a car;

FIG. 10 is a bottom view showing the electrically-conductive insert mechanically fastened within the radome of the antenna assembly shown in FIG. 4;

FIG. 11 is a line graph of linear average passive gain (vertical polarization) in decibels-isotropic (dBi) versus frequency (including FM frequencies from 76 megahertz (MHz) to 108 MHz) measured for a prototype of the AM/FM/DAB antenna shown in FIGS. 6 and 7 on a one-meter diameter generally circular rolled edge ground plane;

FIG. 12 is a line graph of linear average passive gain (vertical polarization) in decibels-isotropic (dBi) versus frequency (including DAB frequencies from 174 MHz to 240 MHz) measured for the prototype of the AM/FM/DAB antenna shown in FIGS. 6 and 7 on a one-meter diameter generally circular rolled edge ground plane;

FIG. 13 is a line graph of passive gain (dBi) versus frequency (including FM frequencies from 76 megahertz (MHz) to 108 MHz) measured for a prototype of the AM/FM/DAB antenna shown in FIGS. 6 and 7 on a one-meter diameter generally circular rolled edge ground plane;

FIGS. 14 through 21 illustrate radiation patterns (linear average gain, vertical polarization) measured at various FM frequencies for the prototype of the AM/FM/DAB antenna shown in FIGS. 6 and 7 on a one-meter diameter generally circular rolled edge ground plane; and

FIGS. 22 through 26 illustrate radiation patterns (linear average gain, vertical polarization) measured at various DAB frequencies for the prototype of the AM/FM/DAB antenna shown in FIGS. 6 and 7 on a one-meter diameter generally circular rolled edge ground plane.

Corresponding reference numerals indicate corresponding parts throughout the several views of the drawings.

### DETAILED DESCRIPTION

Example embodiments will now be described more fully with reference to the accompanying drawings.

The inventors hereof recognized a need for smaller or compact multiband vehicular antenna assemblies (e.g., shark fin antenna assemblies, etc.) that are operable over or configured for use with multiple frequency bands, including AM (amplitude modulation), FM (frequency modulation), and DAB (digital audio broadcasting). Conventionally, two separate antenna mast structures have been used for AM/FM/DAB-III signals with one antenna mast structure for AM/FM and another separate antenna mast structure for DAB-III.

After recognizing the above, the inventors developed and disclose herein exemplary embodiments of AM/FM/DAB antenna mast structures that are operable for receiving AM/FM and DAB-III. In exemplary embodiments, there is only one AM/FM/DAB antenna mast structure is relatively short (e.g., 55 millimeters tall, etc.), top loaded, and multiband via electrical conductors that define a single or singular multiband resonant structure operable with AM, FM, and DAB-III frequencies.

By using a single multiband resonant structure that is operable with AM, FM, and DAB-III frequencies, exemplary embodiments may allow overall costs to be reduced for an antenna assembly (e.g., vehicular multiband shark fin antenna assembly, helically wound “rubber duck” type mast antenna, etc.). With a single multiband resonant structure, there may also be more space available in the antenna assembly for other content, such as a satellite navigation antenna (e.g., global positioning system (GPS) patch antenna, global navigation satellite system (GLONASS) patch antenna, other patch antenna, etc.), a cellular antenna (e.g., an inverted-F antenna (IFA), a monopole antenna, an inverted L antenna (ILA), a planar inverted F antenna (PIFA), a stamped mast antenna, etc.), a DAB-L band antenna (e.g., a monopole antenna, etc.), and/or an antenna (e.g., a satellite patch antenna, etc.) configured for other frequency bands, etc.

Also disclosed herein are exemplary embodiments of multiband vehicular antenna assemblies or systems that include an AM/FM/DAB antenna. An antenna assembly may have a shark fin antenna style. In such exemplary embodiments, the AM/FM/DAB antenna has good electrical antenna performance (e.g., better than some existing antennas, etc.) that meets the stringent specifications and requirements for performance in Europe and the US. A shark fin antenna assembly (or other antenna assembly) including an AM/FM/DAB antenna disclosed herein may have a smaller and more compact size than some existing antenna assemblies while providing the same or greater content in a smaller overall package.

An AM/FM/DAB antenna disclosed herein may be used with one or more other antennas in a shark fin (or other) antenna assembly. For example, an antenna assembly may include an AM/FM/DAB antenna along with one or more of a satellite navigation antenna (e.g., global positioning system (GPS) patch antenna, global navigation satellite system (GLONASS) patch antenna, other patch antenna, etc.), and/or a cellular antenna (e.g., an inverted-F antenna (IFA), a monopole antenna, an inverted L antenna (ILA), a planar inverted F antenna (PIFA), a stamped mast antenna, etc.), a DAB-L band antenna (e.g., a monopole antenna, etc.), and/or an antenna (e.g., a satellite patch antenna, etc.) configured for other frequency bands, etc. Also, for example, an AM/FM/DAB antenna disclosed herein may be used in the place of the AM/FM antenna of any one or more of the antenna assemblies disclosed in U.S. Pat. No. 8,537,062. The entire content of U.S. Pat. No. 8,537,062 is incorporated by reference herein. Accordingly, the AM/FM/DAB antenna disclosed herein should not be limited to use with any one type of other antenna or antenna assembly.

In exemplary embodiments, the AM/FM/DAB antenna is configured for receiving AM/FM/DAB-III signals. The AM/FM/DAB antenna comprises antenna elements (e.g., electrically-conductive traces, etc.) on or along the first and second or opposite sides of a substrate or board. The substrate may comprise a multi-layered printed circuit board (PCB) material, such as a PCB having three layers of FR4 composite material, etc. As disclosed herein, electrically-conductive traces (e.g., copper, etc.) are on or along the first and second or opposite sides of a PCB. The electrically-conductive traces on or along the PCB's first side are electrically connected or interconnected to the electrically-conductive traces on or along the PCB's second side, e.g., by plated thru-holes or vias, etc. The electrically-conductive traces on or along the PCB's first and second sides are operable together as a singular or single dual resonant structure. The electrically-conductive traces along the PCB first side are operable (e.g., simultaneously, collectively, cooperatively, etc.) with the electrical conductors along the second side as a singular multiband resonant structure for AM, FM, and DAB-III frequencies. An inductor and a capacitor are disposed (e.g., surface mounted, etched, soldered, etc.) on or along a first side of the PCB such that the inductor and capacitor are in series. The inductor and capacitor are operable for shorting out portions of the electrically-conductive traces (e.g., short out about three and half turns of the loading coil defined by the traces, etc.) at DAB-III frequencies such that the remaining electrically-conductive traces have a shorter electrical resonating length and are operable at DAB-III frequencies. Accordingly, the electrically-conductive traces (when not shorted by the inductor and capacitor) are operable at a first or primary resonance the FM frequency band from 76 MHz to 108 MHz. When the inductor and capacitor short out portions of the electrically-conductive traces, the electrically-conductive traces are operable at a second or secondary resonance in the DAB-III frequency band from 174 MHz to 240 MHz. Accordingly, the AM/FM/DAB antenna thus has a single or singular resonant element defined by the electrically-conductive traces along or on both sides of the PCB, which single element is multibanded for AM/FM/DAB frequencies with the capacitor and inductor.

In exemplary embodiments, an AM/FM/DAB antenna may include a clip (e.g., electrically-conductive spring clip, etc.) coupled to or within an upper portion of the PCB antenna mast. The clip may be constructed from a suitable electrically-conductive material (e.g., metal, etc.) and is configured to engage an inner electrically-conductive portion (e.g., an insert or top load plate inserted into the cover, etc.) within a radome (e.g., shark fin style radome, etc.) when the radome is positioned over the antenna assembly.

In exemplary embodiments, an AM/FM/DAB antenna may include first and second electrically-conductive elements or structures (e.g., platings, plates, etc.) on or along the upper portions of the first and second sides of the PCB. The first and second electrically-conductive elements may be electrically connected to each other by plated thru-holes or vias extending through the PCB. The top or uppermost trace along the first side of the PCB may be electrically connected (e.g., soldered, integrally formed or etched from the same electrically-conductive material, etc.) to the first electrically-conductive element. The electrically-conductive elements help define a capacitively loaded portion of the AM/FM/DAB antenna.

In some exemplary embodiments, a multiband vehicular antenna assembly includes one or more additional antennas operable within one or more frequency bands different than the AM, FM, DAB-III frequency bands. For example, a multiband vehicular shark fin antenna assembly may be configured for use as a multiple input multiple output (MIMO) antenna assembly operable in the AM, FM, and DAB-III frequency bands via the AM/FM/DAB antenna (e.g., 108, etc.) disclosed herein and operable in one or more other frequency bands, such as frequency bands associated with cellular communications, Wi-Fi, DSRC (Dedicated Short Range Communication), satellite signals, terrestrial signals, etc. For example, a multiband vehicular shark fin antenna assembly may include one or more antennas operable as MIMO LTE (Long Term Evolution) cellular antennas. Additionally, or alternatively, a multiband vehicular shark fin antenna assembly may include one or more satellite antennas, such as a satellite navigation patch antenna operable with global positioning system (GPS) or global navigation satellite system (GLONASS), etc.

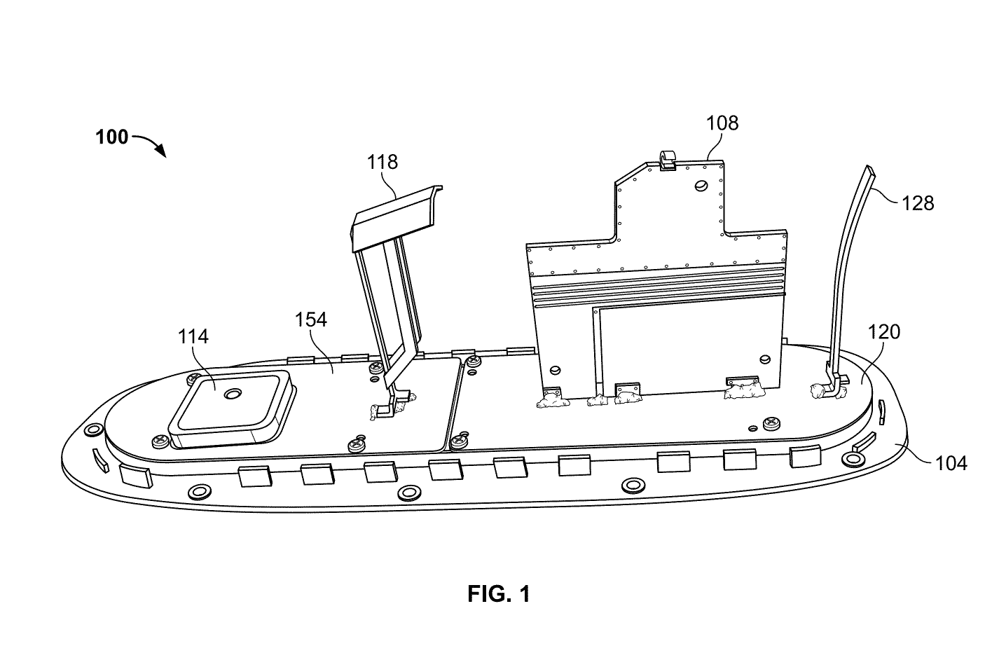

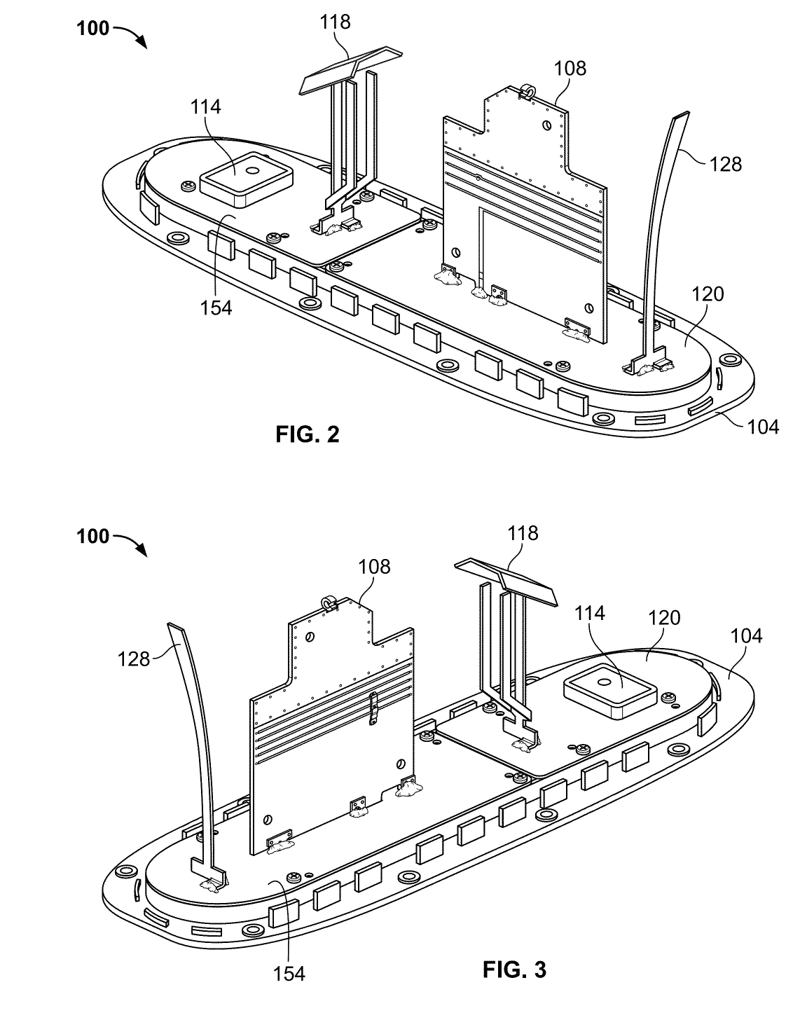

With reference now to the drawings, FIGS. 1 through 5 illustrate an example embodiment of an antenna assembly 100 including at least one or more aspects of the present disclosure. As shown, the antenna assembly 100 includes a chassis 104 (or base) and first, second, and third antennas 108, 114, and 118. The antennas 108, 114, 118, 126 are supported by the chassis 104 and configured to be positioned within an interior enclosure defined generally between the chassis 104 and a radome 156. In this example, the antennas 108, 114, 118, 128 are configured respectively for AM/FM/DAB-III, GPS, cellular, and DAB-L as disclosed herein.

The first antenna 108 is a vertical monopole antenna configured for use with AM, FM, and DABIII frequencies (e.g., configured for receiving desired AM, FM, and DABIII signals, etc.). In this exemplary embodiment, the first antenna 108 includes, is defined by, etc. a first printed circuit board 116 (broadly, a substrate or board). By way of example, the PCB 116 may comprise a multi-layered circuit board (e.g., a PCB having three layers, etc.). For example, the PCB 116 may include first, second, and third layers or portions. The first layer may be a single layer of pre-preg, e.g., having a thickness of 4.3 mils thick, etc. The second layer may be the core FR-4 composite material, e.g., having a thickness of 47 mils thick, etc. FR-4 composite material includes woven fiberglass cloth with an epoxy resin binder that is flame resistant. The third layer may include three layers of pre-preg, e.g., where each layer has a thickness of 4.3 mils or total 12.9 mil thickness for all three layers of pre-preg, etc.

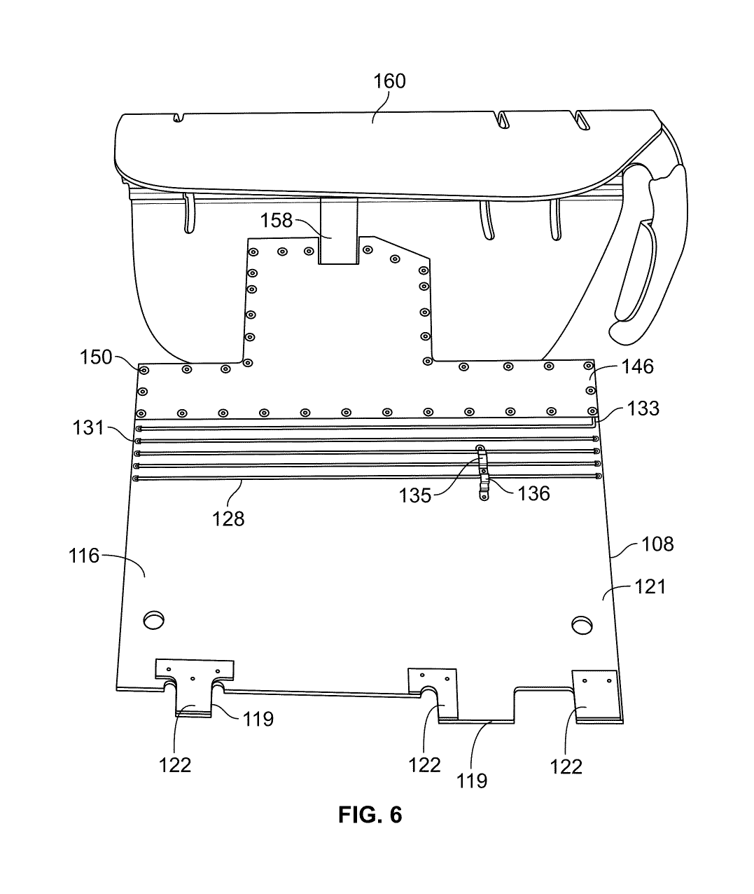

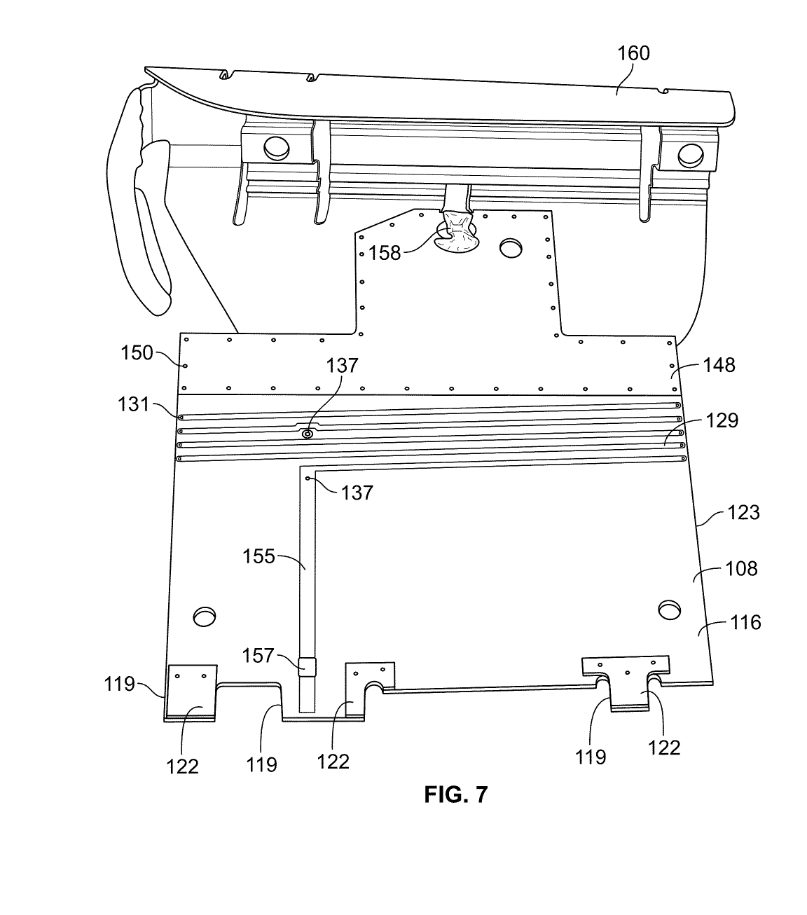

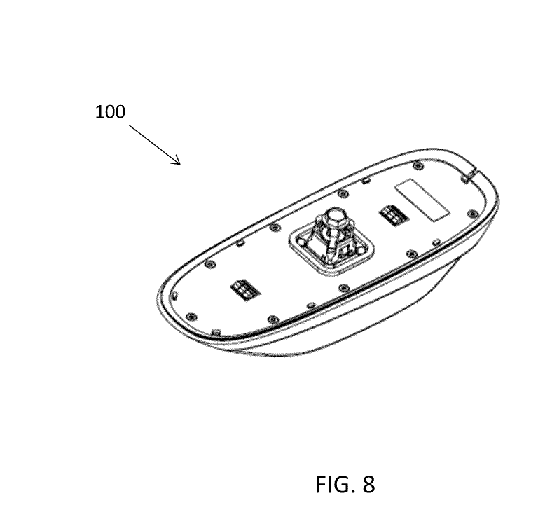

The first PCB 116 is coupled to another or second printed circuit board 120. The first PCB 116 is generally perpendicular to the second PCB 120. The second PCB 120 is coupled to the chassis 104 by mechanical fasteners 124. The first PCB 116 may be coupled to the second PCB 120 by solder, etc. For example, FIGS. 6 and 7 show soldering areas 122 (e.g., electrically-conductive plated areas, etc.) of the first PCB 116 at which solder may be applied to solder the first PCB 116 to the second PCB 120. Other suitable couplings may be used as desired. In addition, the first PCB 116 may include tab portions 119 that extend downwardly and interconnect with corresponding slots or openings 125 of the PCB 120 to further help position the first PCB 116 relative to the second PCB 120 and/or to help couple the first PCB 116 with (e.g., on, to, etc.) the second PCB 120.

FIGS. 6 and 7 illustrate first and second opposite sides 121, 123, respectively, of the exemplary embodiment of the AM/FM/DAB antenna 108 that may be used with the antenna assembly 100 (FIGS. 1-5). Electrically-conductive traces 128, 129 (broadly, electrical conductors or antenna elements) are provided along (e.g., a middle portion of, etc.) the respective first and second sides 121, 123 of the first PCB 116. The electrically-conductive traces 128 on or along the PCB's first side 121 (FIG. 6) are electrically connected or interconnected to the electrically-conductive traces 129 on or along the PCB's second side 123 (FIG. 7), e.g., by plated thru-holes or vias 131 that extend through the PCB 116, etc. As another example, the electrically-conductive traces 128 and/or 129 may extend completely around the side edges of the PCB 116 such that the traces essentially define a single or singular resonant element or electrical path that continuously coils or extends around sides 121, 123 and edges of the PCB 116. In alternative embodiments, the electrically-conductive traces 128 along the PCB's first side 121 may be proximity coupled to the electrically-conductive traces 129 along the PCB's second side 123. In still other embodiments, the electrically-conductive traces 128 and 129 and vias 131 may be replaced by only one electrically-conductive element (e.g., electrically-conductive wire, etc.) with electrically-conductive portions (broadly, electrical conductors) along the PCB sides and that extend completely around the side edges.

With continued reference to FIGS. 6 and 7, the traces 128, 129 define a continuous electrical path (e.g., generally rectangular shaped coil, etc.) generally coiling, winding, or extending around at least part of the AM/FM/DAB antenna PCB 116. The electrically-conductive traces 128, 129 along the PCB's first and second sides 121, 123 are operable as a single or singular resonant structure for AM, FM, and DAB-III frequencies. The traces 128, 129 may define an inductively loaded portion or loading coil of the AM/FM/DAB antenna 108 along the opposite sides 121, 123 of the PCB 116. In operation, the electrically-conductive traces 128, 129 are operable for inductively loading the AM/FM/DAB antenna 108.

As shown in FIG. 6, an inductor 135 and capacitor 136 are disposed (e.g., surface mounted, etched, soldered, etc.) on or along the first side 121 of the PCB 116. The inductor 135 and capacitor 136 are in series. The inductor 135 and capacitor 136 are electrically connected to the traces 129 and 155 on the PCB's second side 123 (FIG. 7), e.g., by plated thru-holes or vias 137 that extend through the PCB 116, etc. The inductor 135 and capacitor 136 are operable for shorting out portions of the electrically-conductive traces 128, 129 (e.g., short out three and half turns of the loading coil, etc.) at DAB-III frequencies. The remaining (not shorted) electrically-conductive traces 128, 129 have a shorter electrical resonating length and are thus operable at DAB-III frequencies.

The electrically-conductive traces 128, 129 (when not shorted by the inductor 135 and capacitor 136) are operable at a first or primary resonance in the FM frequency band from 76 MHz to 108 MHz. When the inductor 135 and capacitor 136 short out portions of the electrically-conductive traces 128, 129, the electrically-conductive traces 128, 129 are operable at a second or secondary resonance in the DAB-III frequency band from 174 MHz to 240 MHz. The electrically-conductive traces 128, 129 may also be operable in the AM frequency band from 535 kilohertz (kHz) to 1605 kHz. Although there may be no AM resonance on the antenna mast, the antenna 108 may still pick up and operate normally for AM frequencies from 535 kilohertz (kHz) to 1605 kHz.

Accordingly, the AM/FM/DAB antenna 108 thus has a singular resonant element defined by the electrically-conductive traces 128, 129 along or on both sides 121, 123 of the PCB 116, which singular resonant element is multibanded for AM/FM/DAB frequencies with the inductor 135 and capacitor 136. This is unlike other PCB AM/FM antennas in which separate antenna elements that are operable or resonant in different frequency bands (e.g., AM and FM antenna elements, etc.) are on opposite sides of a PCB.

In this illustrated embodiment, there are five traces 128, 129 (e.g., copper traces etched, etc.) along each of the first and second sides 121, 123 of the PCB 116. The traces 128 on the first side 121 of the PCB 116 are generally straight, horizontal, and parallel. A bending portion or point 133 connects the top or uppermost trace 128 to a first electrically-conductive element or structure 146 (e.g., plating, plate, etc.), which is along or on an upper portion of the first side 121 of the PCB 116.

The traces 129 on the second side 123 of the PCB 116 are generally straight, parallel, and angled slightly upward (from left to right in FIG. 7) relative to the bottom edge of the PCB 116. The bottom trace 129 is electrically connected to a vertical trace 155 (broadly, feed line or transmission line). The trace 155 extends downward for electrically connecting the traces 128, 129 of the first PCB 116 (e.g., via soldering at a feed point on the first PCB 116, etc.) to the second PCB 120. Alternative embodiments may include other means for electrically connecting the traces 128, 129 to the PCB 120. For example, a coupling wire may be used to electrically connect the AM/FM/DAB antenna 108 to the PCB 120. The coupling wire may connect through the PCB 120 (e.g., via a solder connection, etc.) to the lower trace on the PCB 116. A patch 157 of solder mask may be provided along the vertical trace 155 toward a bottom of the trace 155. The solder mask helps inhibit or prevent solder from flowing up the trace 155 when the trace 155 is being soldered to the PCB 120.

By way of example only, the traces 128 on the first PCB side 121 may have an overall length of about 54 millimeters (mm) with a height of 54 millimeters and width of 1.5 millimeters. The traces 129 on the second PCB side 123 may have an overall length of about 54 millimeters with a height of 54 millimeters and width of 1.5 millimeters. Also by way of example, the PCB 116 may have a height of 54 millimeters, a width of about 54 millimeters, and a thickness of about 0.8 millimeters. Other exemplary embodiments may include other numbers of traces and/or be sized differently. In addition, the number of traces on each side of the PCB 116 may be different. Accordingly, the number of traces and the dimensions are provided for purpose of illustration only, as the antenna 108 may be configured differently (e.g., larger, smaller, shaped differently, with a different layout of traces, etc.) in other exemplary embodiments.

Also in this exemplary embodiment, first and second electrically-conductive elements or structures 146, 148 (e.g., electrically-conductive platings, etc.) are on or along upper portions of the respective first side (FIG. 6) and second side (FIG. 7) of the PCB 116. The first and second electrically-conductive elements 146, 148 are electrically connected to each other, e.g., by plated thru-holes or vias 150 extending through the PCB 116, etc. The bending point 133 electrically connects the top or uppermost trace 128 along the first side 121 of the PCB 116 to the first electrically-conductive element 146. The first and second electrically-conductive elements 146, 148 define a capacitively loaded portion of the AM/FM/DAB antenna 108 towards an upper portion of the antenna 108. The AM/FM/DAB antenna 108 and its components (e.g., PCB 116, traces 128, 129, and elements 146, 148, etc.) may also be referred to herein as an antenna mast structure.

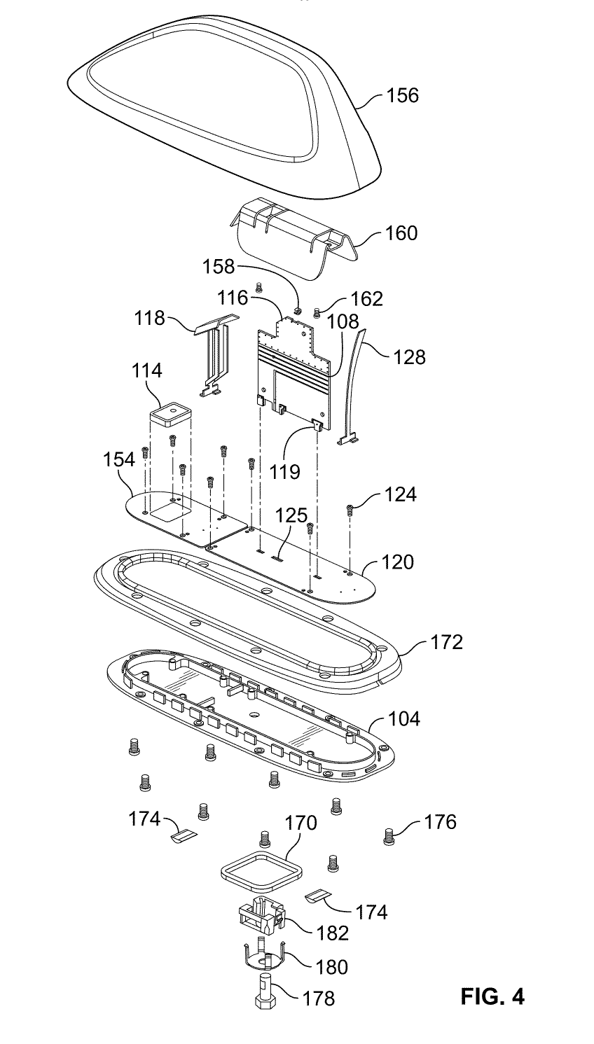

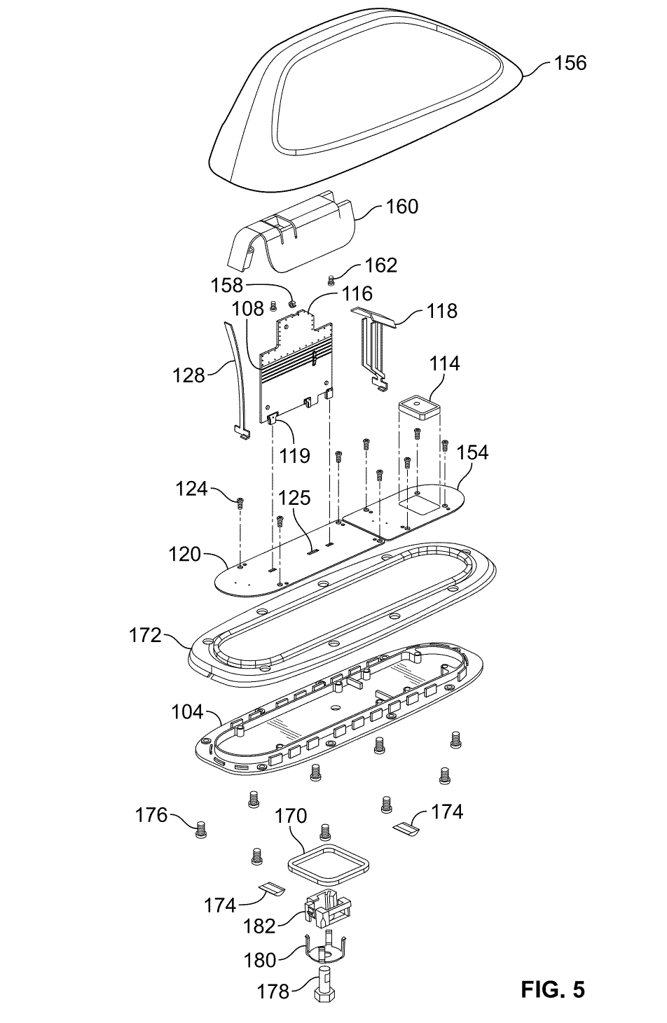

A clip 158 (e.g., electrically-conductive spring clip, etc.) is coupled to (e.g., soldered, positioned within an opening or slot, etc.) an upper portion of the AM/FM/DAB antenna PCB 116. The clip 158 may be constructed from a suitable electrically conductive material (e.g., metal, etc.). The clip 158 is configured to electrically connect to an insert 160 (e.g., a top load plate inserted into the radome or cover, etc.) that is positioned and mechanically fastened (e.g., by mechanical fasteners 162 (FIGS. 4 and 5), etc.) within the radome 156. As such, the clip 158 may operate to establish electrical contact between the AM/FM/DAB antenna 108 and the insert 160, whereby the insert 160 operates to form a capacitive load portion of the AM/FM/DAB antenna 108. In an exemplary embodiment, the clip is generally C-shaped and defines a generally English-language letter C shape. In other example embodiments, antenna assemblies can have clips with other suitable shapes or no clips at all.

The antenna 108 is configured or tuned to be operable at frequencies within the AM frequency band, FM frequency band, and DABIII frequency band. In some embodiments, the antenna 108 may be configured to be resonant across the AM, FM, and DABIII frequency bands or across only portions of one of these bands. The antenna 108 may be tuned as desired for operation at desired frequency bands by, for example, adjusting size and/or number and/or orientation and/or type of the traces 128, 129 provided along the first and second sides 121, 123 of the PCB 116, etc. For example, the antenna 108 could be tuned (or retuned), as desired, to Japanese FM frequencies (e.g., including frequencies between about 76 MHz and about 93 MHz, etc.), DAB-VHF-III (e.g., including frequencies between about 174 MHz and about 240 MHz, etc.), other similar VHF bands, other frequency bands, etc.

In some exemplary embodiments, a multiband vehicular shark fin antenna assembly may include only the AM/FM/DAB antenna 108 as described above. In other exemplary embodiments, a multiband vehicular shark fin antenna assembly may include the AM/FM/DAB antenna 108 and one or more other antennas operable within one or more frequency bands different than the AM, FM, DAB-III frequency bands.

For the illustrated embodiment shown in FIGS. 1 through 5, the multiband vehicular shark fin antenna assembly 100 includes second, third, and fourth antennas 114, 118, and 128 in addition to the AM/FM/DAB antenna 108. In this example, the second antenna 114 is operable with satellite navigation signals (e.g., global positioning system (GPS), global navigation satellite system (GLONASS), etc.). The third antenna 118 is operable with cellular signals (e.g., Long Term Evolution (LTE), etc.). The fourth antenna 128 is operable with DAB-L signals (e.g., DAB-L frequency band from 1452 MHz to 1492 MHz, etc.).

As shown in FIGS. 1 through 5, the second antenna 114 comprises a patch antenna coupled to a third PCB 154. The PCB 154 is coupled to the chassis 104 by mechanical fasteners 124 at a location toward a forward portion of the chassis 104 in front of the first antenna 108. The second antenna 114 is electrically coupled to the third PCB 154 as desired (e.g., by a patch pin 164, etc.) and fastened thereto, e.g., by a mechanical fastener, etc. The second antenna 114 may be operable at one or more desired frequencies including, for example, GPS frequencies or GLONASS frequencies, etc. And, the second antenna 114 may be tuned as desired for operation at desired frequency bands by, for example, changing dielectric materials, changing sizes of metal plating, etc. used in connection with the second antenna 114, etc.

The third antenna 118 comprises a multiband vertical monopole antenna (e.g., stamped and bent metal, etc.) configured for use with cellular phones (e.g., for receiving desired cellular phone signals, etc.). The third antenna 118 is coupled (e.g., soldered, etc.) to the second PCB 120 at a location adjacent and between the first antenna 108 and the second antenna 114. Other exemplary embodiments may comprise MIMO cellular antennas that comprise inverted-F antennas (IFAs). For example, another exemplary embodiment may include a primary cellular antenna configured to be operable for both receiving and transmitting communication signals within one or more cellular frequency bands (e.g., LTE, etc.), and a secondary cellular antenna configured to be operable for receiving (but not transmitting) communication signals within one or more cellular frequency bands (e.g., LTE, etc.). Other exemplary embodiments may comprise one or more cellular antennas configured differently, such as a monopole antenna, an inverted L antenna (ILA), a planar inverted F antenna (PIFA), a stamped mast antenna (e.g., stamped and bent sheet metal, etc.), an antenna made of different materials and/or via different manufacturing processes, etc.

The fourth antenna 128 comprises a vertical monopole antenna (e.g., stamped and bent metal, etc.) configured for use with the DAB-L frequency band from 1452 MHz to 1492 MHz. The fourth antenna 128 is coupled to (e.g., soldered to, etc.) the second PCB 120 at a location toward a rearward portion of the chassis 104. The first antenna 108 is between the third antenna 114 and the fourth antenna 128. Other exemplary embodiments may comprise one or more antennas configured differently, e.g., configured for different frequencies, made of different materials, and/or via different manufacturing processes, etc.

The antenna assembly 100 includes a sealing member 170 (e.g., an O-ring, a resiliently compressible elastomeric or foam gasket, a PORON microcellular urethane foam gasket, etc.) that will be positioned between the chassis 104 and the roof of a car (or other mounting surface). The sealing member 170 may substantially seal the chassis 104 against the roof and substantially seal the mounting hole in the roof. The antenna assembly 100 also includes a sealing member 172 (e.g., an O-ring, a resiliently compressible elastomeric or foam gasket, caulk, adhesives, other suitable packing or sealing members, etc.) that is positioned between the radome 156 and the chassis 104 for substantially sealing the radome 156 against the chassis 104. In this example, the sealing member 172 may be at least partially seated within a groove defined along or by the chassis 104.

The antenna assembly 100 includes gaskets 174. In operation, the gaskets 174 help ensure that the chassis 104 will be grounded to a vehicle roof and also allows the antenna assembly 100 to be used with different roof curvatures. The gaskets 174 may include electrically-conductive fingers (e.g., metallic or metal spring fingers, etc.). In an exemplary embodiment, the gaskets 174 comprise fingerstock gaskets from Laird Technologies, Inc.

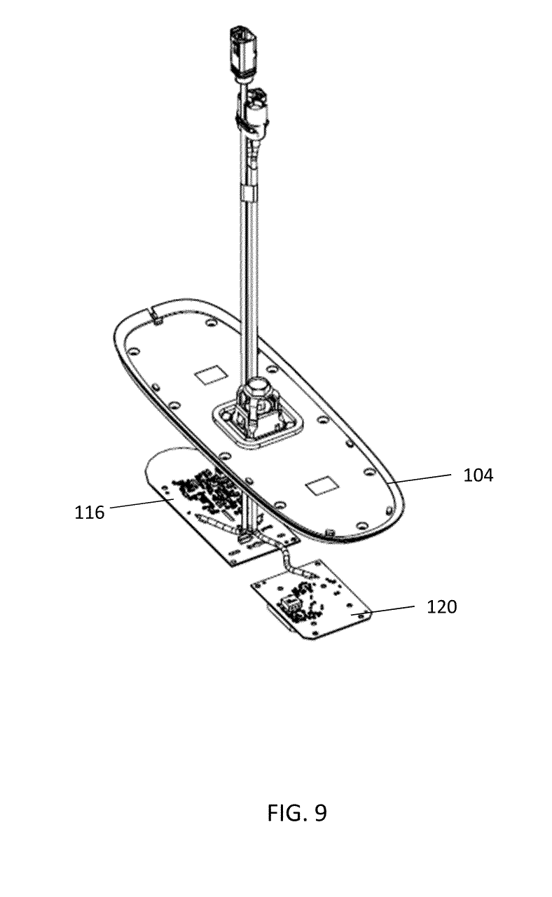

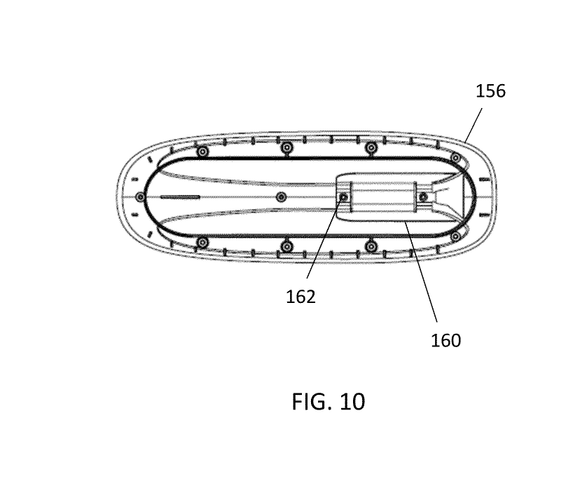

An electrical connector (FIG. 9) may be used for coupling the antenna assembly 100 to a suitable communication link (e.g., a coaxial cable, etc.) in a mobile platform or vehicle (e.g., through an opening in the chassis 104 aligned with an opening in a roof of a car, etc.). In this exemplary way, the PCBs may receive signal inputs from the respective antennas, process the signal inputs, and transmit the processed signal inputs to the suitable communication link. Alternatively, or in addition, one or more PCBs may process signal inputs to be transmitted via or through the one or more respective antennas. The electrical connector may be an ISO (International Standards Organization) standard electrical connector or a Fakra connector attached to one or more of the PCBs. A coaxial cable (or other suitable communication link) may be relatively easily connected to the electrical connector and used for communicating signals received by the antennas to devices in the vehicle. In such embodiments, the use of standard ISO electrical connectors or Fakra connectors may allow for reduced costs as compared to those antenna installations that require a customized design and tooling for the electrical connection between the antenna assembly and cable. In addition, the pluggable electrical connections between the communication link and the antenna assembly's electrical connector may be accomplished by the installer without the installer having to complexly route wiring or cabling through the vehicle body wall. Accordingly, the pluggable electrical connection may be easily accomplished without requiring any particular technical and/or skilled operations on the part of the installer. Alternative embodiments may include using other types of electrical connectors and communication links (e.g., pig tail connections, etc.) besides standard ISO electrical connectors, Fakra connectors, and coaxial cables.

In an exemplary embodiment, the radome 156 is a shark fin style radome having a length of 220 millimeters, a height of 68 millimeters, a maximum width of about 78 millimeters, and a minimum width (near the top) of 20 millimeters. The radome 156 can substantially seal the components of the antenna assembly 100 within the radome 156 thereby protecting the components against ingress of contaminants (e.g., dust, moisture, etc.) into an interior enclosure of the radome 156. In addition, the radome 156 can provide an aesthetically pleasing appearance to the antenna assembly 100, and can be configured (e.g., sized, shaped, constructed, etc.) with an aerodynamic configuration. In the illustrated embodiment, for example, the radome 156 has an aesthetically pleasing, aerodynamic shark-fin configuration. In other example embodiments, however, antenna assemblies may include radomes having configurations different than illustrated herein, for example, having configurations other than shark-fin configurations, etc. The radome 156 may also be formed from a wide range of materials, such as, for example, polymers, urethanes, plastic materials (e.g., polycarbonate blends, Polycarbonate-Acrylnitril-Butadien-Styrol-Copolymer (PC/ABS) blend, etc.), glass-reinforced plastic materials, synthetic resin materials, thermoplastic materials (e.g., GE Plastics Geloy® XP4034 Resin, etc.), etc. within the scope of the present disclosure.

The radome 156 is configured to fit over the first, second, and third 108, 114, and 118 and the PCBs 116, 120, and 154. The radome 156 is configured to be secured to the chassis 104. And, the chassis 104 is configured to couple to a vehicle body wall, e.g., a roof of a car, etc. The radome 156 may secure to the chassis 104 via any suitable operation, for example, a snap fit connection, mechanical fasteners (e.g., screws, other fastening devices, etc.), ultrasonic welding, solvent welding, heat staking, latching, bayonet connections, hook connections, integrated fastening features, etc. In the illustrated embodiment shown in FIGS. 4 and 5, the radome 156 may be secured to the chassis by screws 176. Alternatively, the radome 156 may connect directly to a vehicle body wall within the scope of the present disclosure.

The chassis 104 may be formed from materials similar to those used to form the radome 156. For example, the material of the chassis 104 may be formed from one or more alloys, e.g., zinc alloy, etc. Alternatively, the chassis 104 may be formed from plastic, injection molded from polymer, steel, and other materials (including composites) by a suitable forming process, for example, a die cast process, etc. within the scope of the present disclosure.

The antenna assembly 100 also includes a fastener member 178 (e.g., threaded mounting bolt having a hexagonal head, etc.), a first retention component 180 (e.g., retaining clip, etc.), and a second retention component 182 (e.g., an insulator clip, etc.). The fastener member 178 and retention members 180, 182 may be used to mount the antenna assembly 100 to an automobile roof, hood, trunk (e.g., with an unobstructed view overhead or toward the zenith, etc.) where the mounting surface of the automobile acts as a ground plane for the antenna assembly 100 and improves reception of signals. The relatively large size of the ground plane (e.g., a car roof, etc.) improves reception of radio signals having generally lower frequencies. And, the large size of the ground plane would not be considered negligible compared to the operating wavelength of the AM/FM/DAB antenna 108.

The first retaining component 180 includes legs, and the second retaining component 182 includes tapered faces. The legs of the first retaining component 180 are configured to make contact with the corresponding tapered faces of the second retaining component 182. The first and second retaining components 180, 182 also include aligned openings through which passes the fastener member 178 to be threadedly connected to a threaded opening in the chassis 104.

The fastener member 178 and retaining components 180, 182 allow the antenna assembly 100 to be installed and fixedly mounted to a vehicle body wall. The fastener member 178 and retaining components 180, 182 may first be assembled onto the chassis 104 before the antenna installation onto the vehicle. Then, the antenna assembly 100 may be positioned (from the external side of the vehicle) relative to a mounting hole in the vehicle body wall such that the fastener member 178 and retaining components 180, 182 are inserted into the mounting hole (e.g., pulled downward through the mounting hole, etc.). The chassis 104 is then disposed along the external side of the vehicle body wall. The fastener 178 is accessible from inside the vehicle. In this stage of the installation process, the antenna assembly 100 may thus be held in place relative to the vehicle body wall in a first installed position.

When the first retaining component 180 is compressively moved generally towards the mounting hole by driving the fastener member 178 in a direction generally towards the antenna base 104, the legs of first retaining component 180 may deform and expand generally outwardly relative to the mounting hole against the interior compartment side of the vehicle body wall, thereby securing the antenna assembly 100 to the vehicle body wall in a second, operational installed position. This installation process is but one example way to install the antenna assembly 100 to a vehicle. Alternative mechanisms, processes, and means may also be used for installing an antenna assembly (e.g., antenna assembly 100, etc.) to a vehicle in exemplary embodiments.

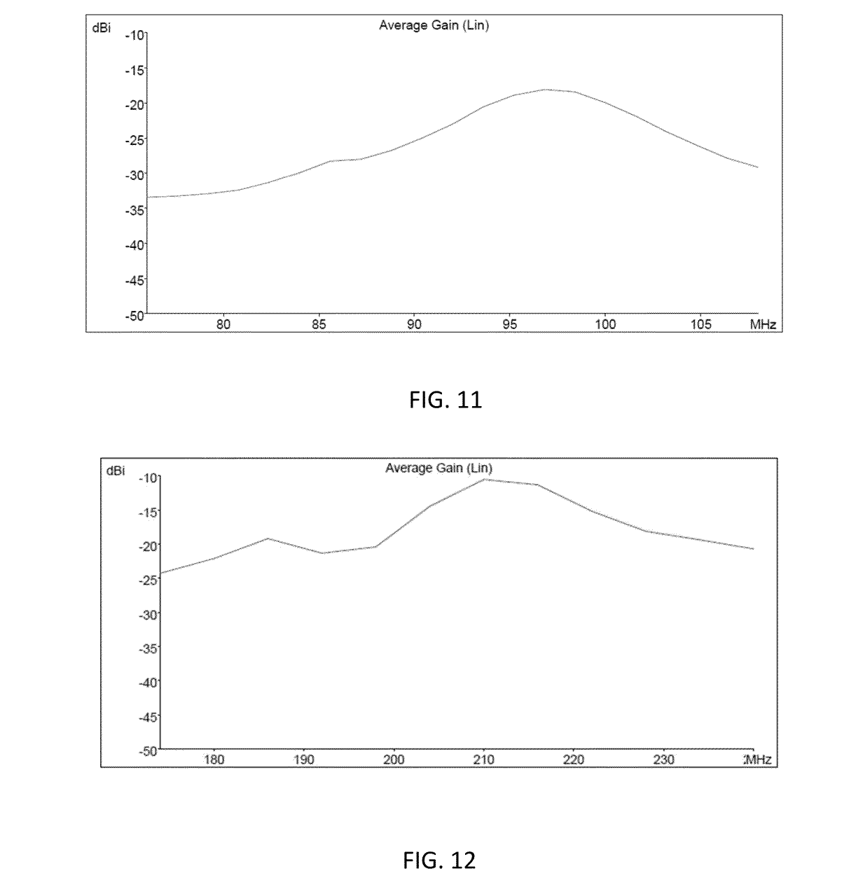

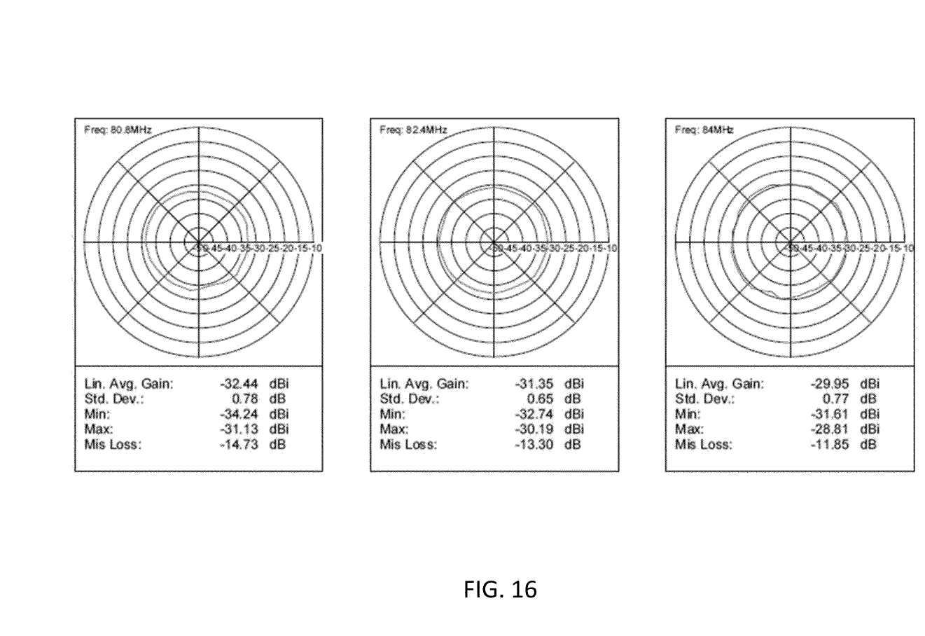

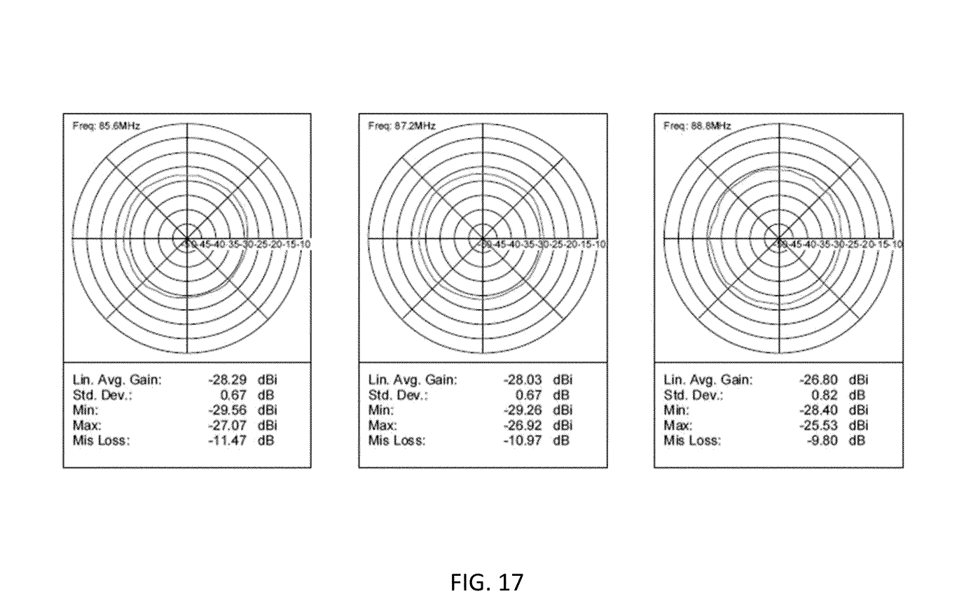

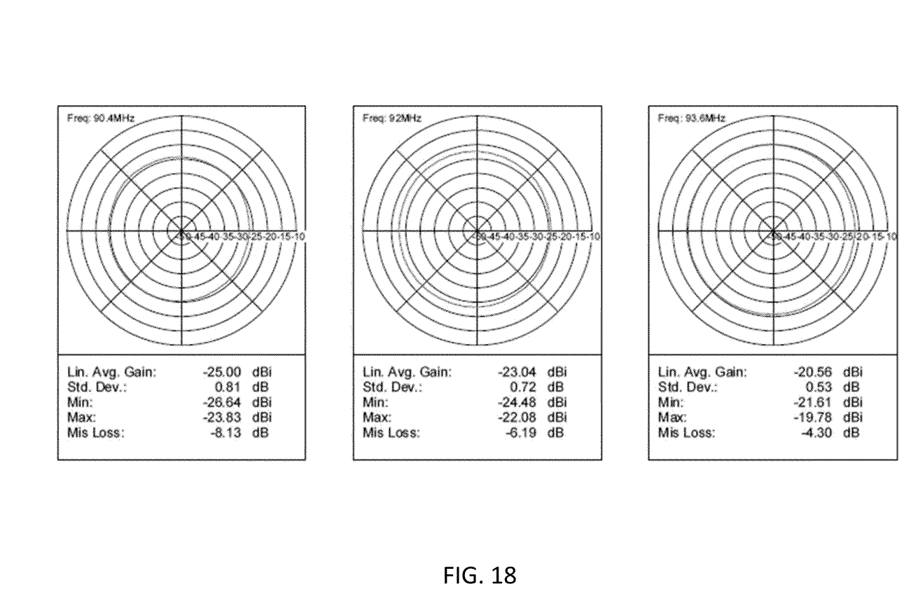

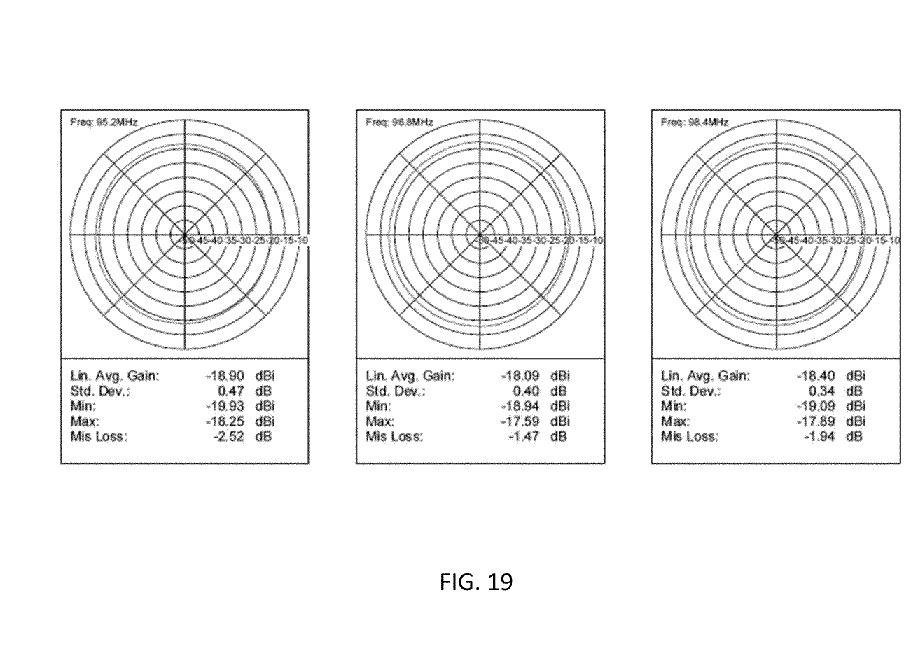

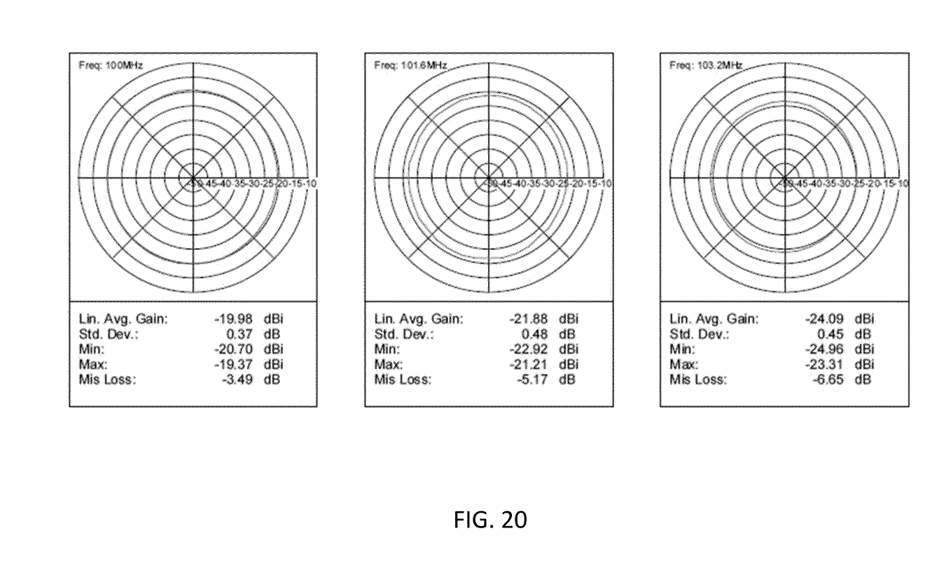

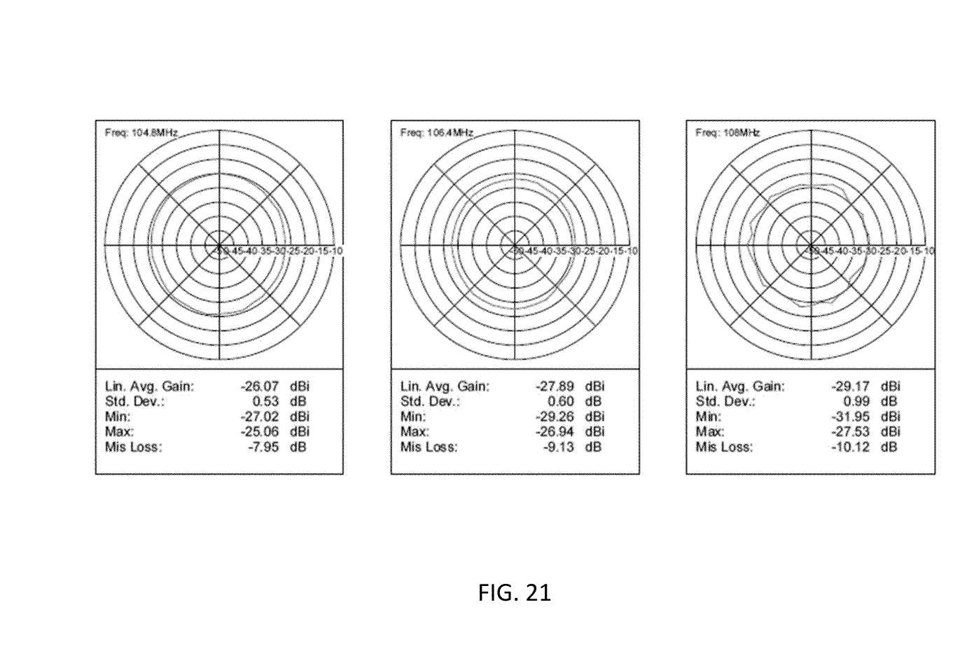

FIGS. 11 through 26 provide analysis results measured for a prototype of the AM/FM/DAB antenna 108 shown in FIGS. 6 and 7. These analysis results shown in FIGS. 11 through 26 are provided only for purposes of illustration and not for purposes of limitation. Generally, these results show that the antenna assembly has good AM/FM/DAB performance even with its relatively small or compact overall size as compared to some existing shark fin antennas. In alternative embodiments, the antenna assembly may be configured differently and have different operational or performance parameters than what is shown in FIGS. 11 through 26.

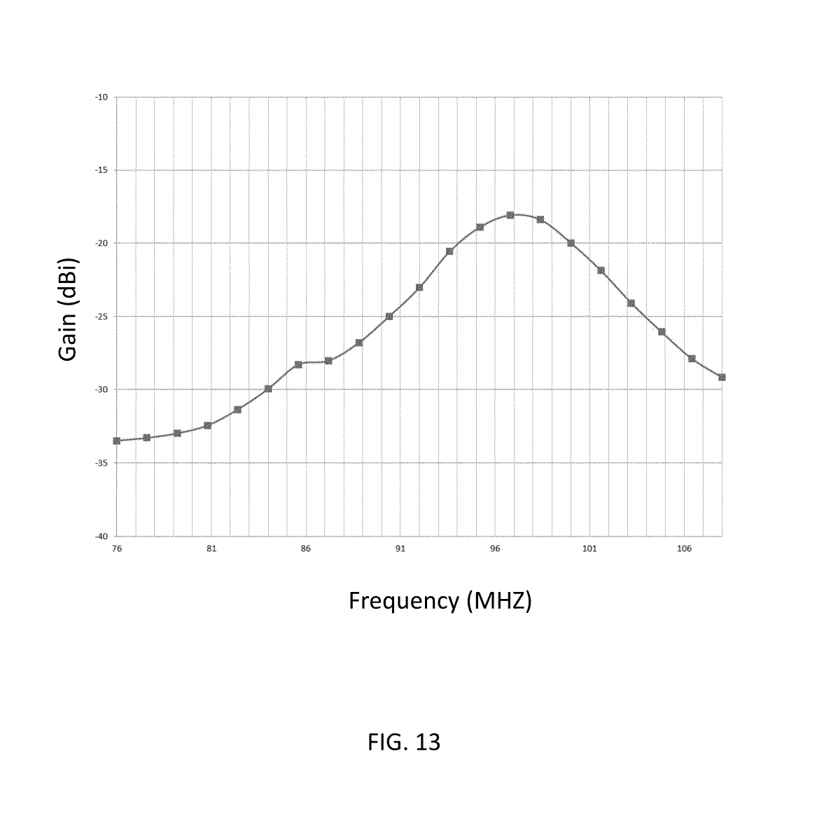

FIGS. 11 and 12 are line graphs of linear average passive gain (vertical polarization) in decibels-isotropic (dBi) versus frequency measured for a prototype of the AM/FM/DAB antenna 108 shown in FIGS. 6 and 7 on a one-meter diameter generally circular rolled edge ground plane. FIG. 11 includes FM frequencies from 76 megahertz (MHz) to 108 MHz, while DAB frequencies from 174 MHz to 240 MHz are shown in FIG. 12. FIG. 13 is a line graph (with corresponding data shown in Table 1 below) of passive gain in decibels-isotropic (dBi) versus frequency in megahertz (MHz) measured for a prototype of the AM/FM/DAB antenna 108 shown in FIGS. 6 and 7 on a one-meter diameter generally circular rolled edge ground plane. As shown by FIGS. 11 through 13, the sample prototype antenna assembly had good linear gain across the entire FM (frequency modulation) frequency band between 76 MHz and 108 MHz. Because an AM/FM/DAB antenna is substantially fixed in its vertical position when an antenna assembly is mounted to a vehicle roof or other location, vertical gain is an important characteristic as it represents the ability of the AM/FM/DAB antenna to receive signals from substantially vertically overhead.

TABLE 1
Example PASSIVE Gain
for AM/FM/DAB Antenna

| Frequency (MHz) | Passive Gain (dBi) |
|---|---|
| 76 | −33.48 |
| 77.6 | −33.29 |
| 79.2 | −32.98 |
| 80.8 | −32.44 |
| 82.4 | −31.35 |
| 84 | −29.95 |
| 85.6 | −28.29 |
| 87.2 | −28.03 |
| 88.8 | −26.8 |
| 90.4 | −25 |
| 92 | −23.04 |
| 93.6 | −20.56 |
| 95.2 | −18.9 |
| 96.8 | −18.09 |
| 98.4 | −18.4 |
| 100 | −19.98 |
| 101.6 | −21.88 |
| 103.2 | −24.09 |
| 104.8 | −26.07 |
| 106.4 | −27.89 |
| 108 | −29.17 |

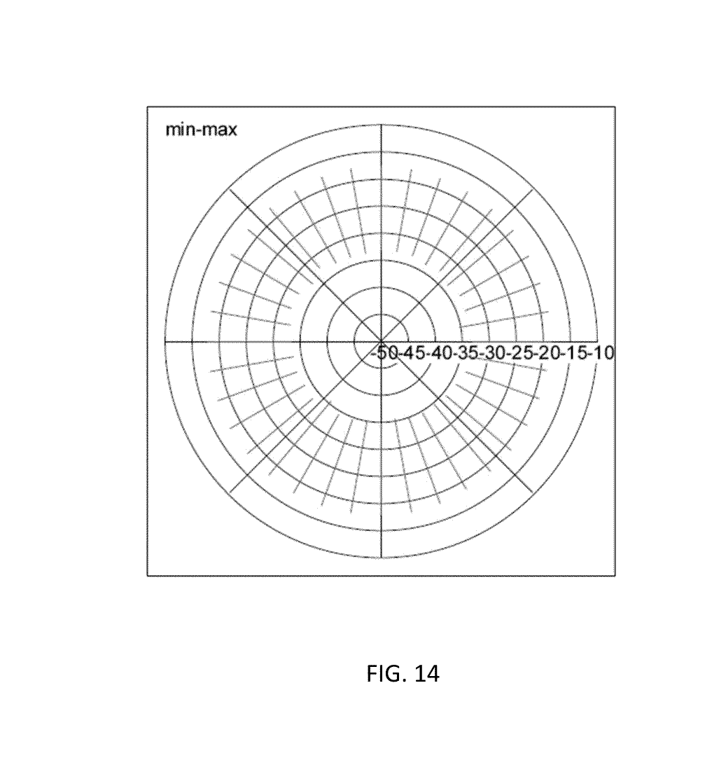

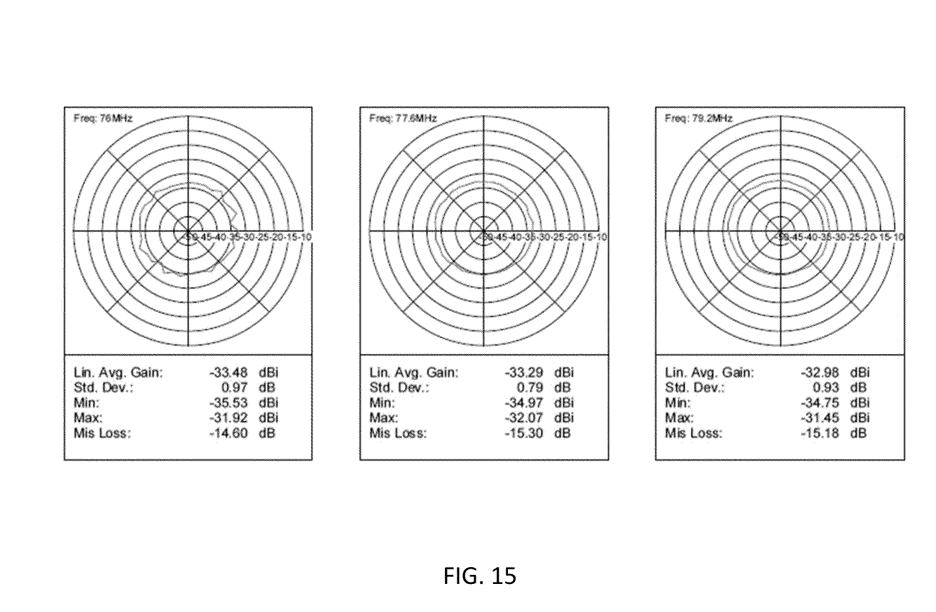

FIGS. 14 through 21 illustrate radiation patterns (linear average gain, vertical polarization) measured at various FM frequencies for the prototype of the AM/FM/DAB antenna 108 shown in FIGS. 6 and 7 on a one-meter diameter generally circular rolled edge ground plane. More specifically, FIG. 14 illustrates minimum and maximum average linear gain for the frequencies shown in the table above, which frequencies are also shown in FIGS. 15 through 21.

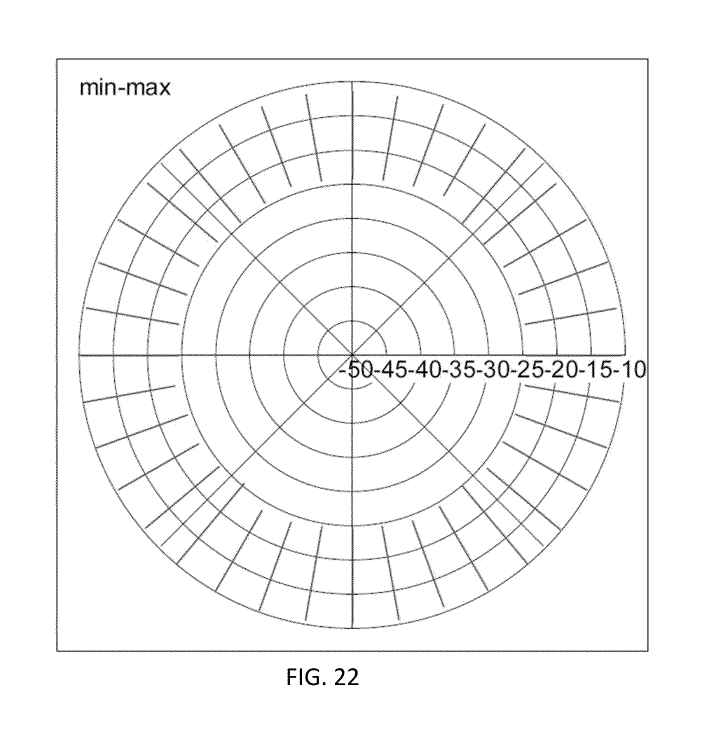

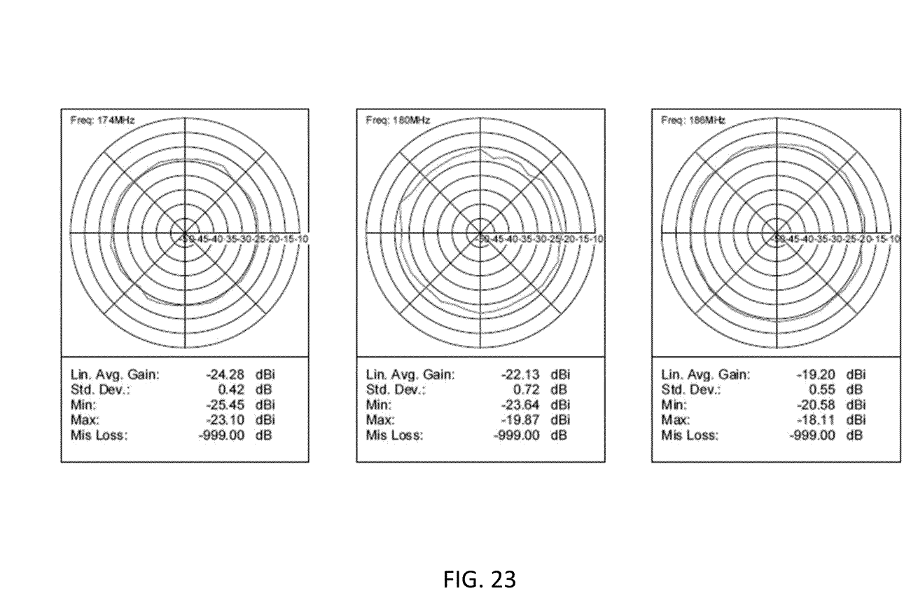

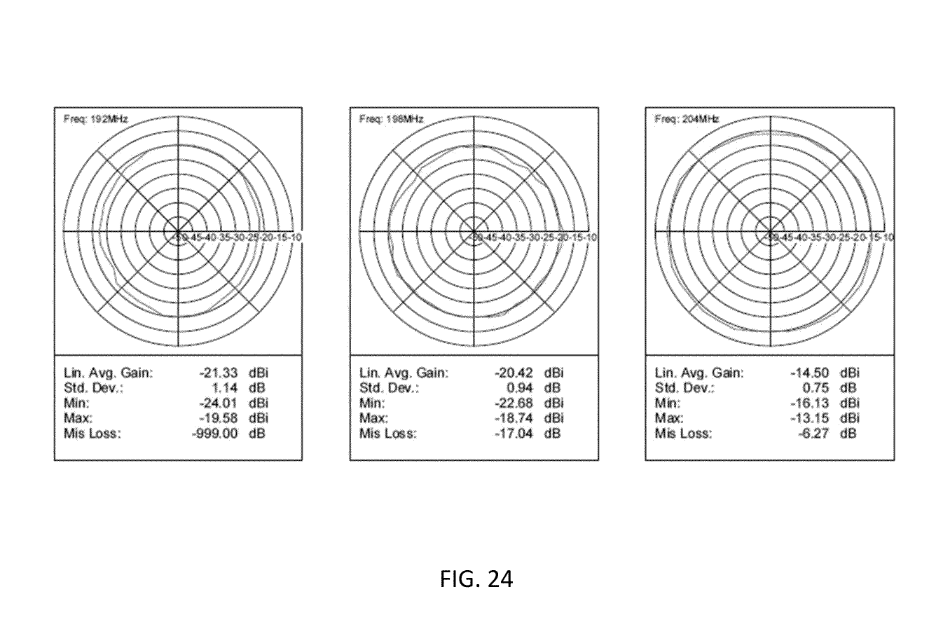

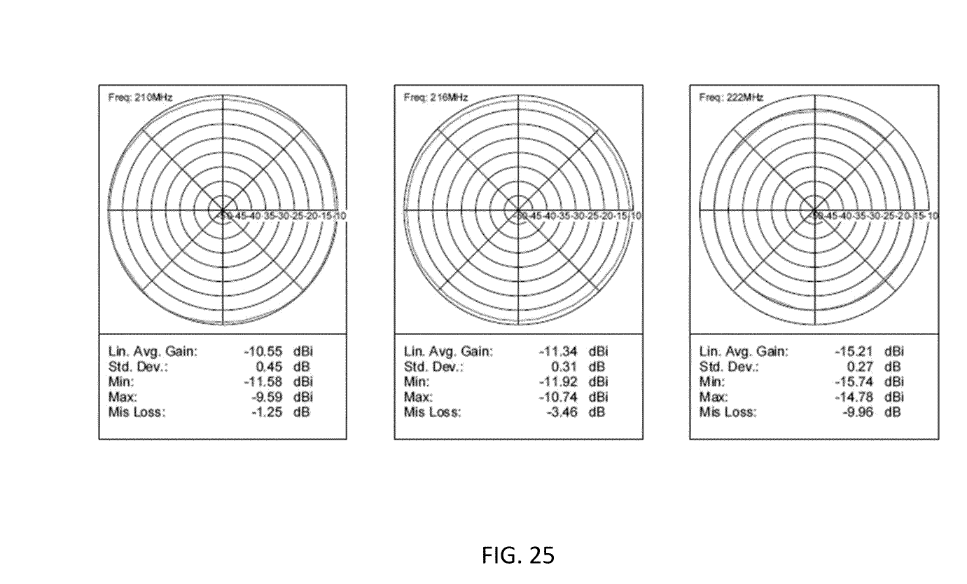

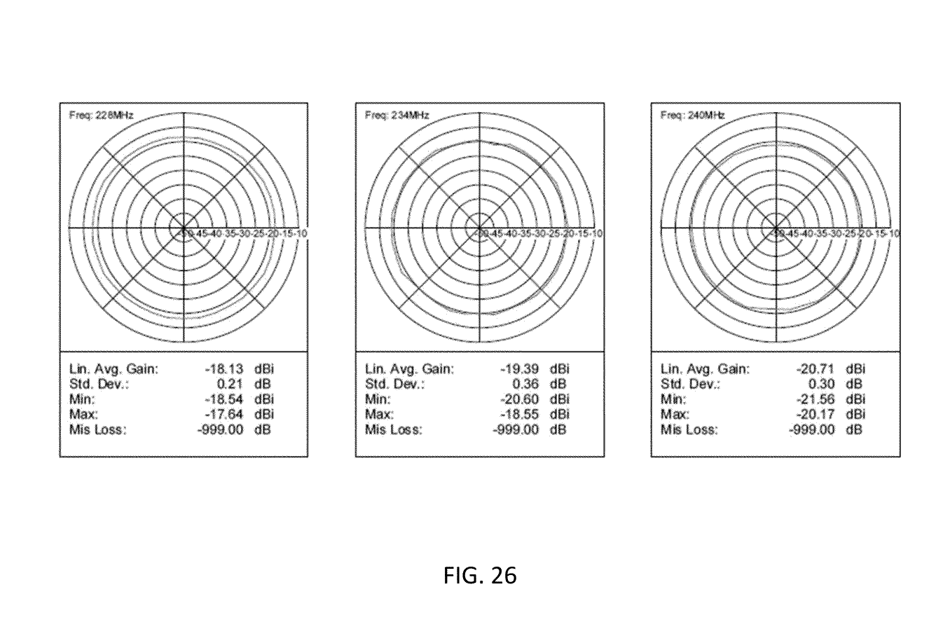

FIGS. 22 through 26 illustrate radiation patterns (linear average gain, vertical polarization) measured at various DAB frequencies for the prototype of the AM/FM/DAB antenna 108 shown in FIGS. 6 and 7 on a one-meter diameter generally circular rolled edge ground plane. More specifically, FIG. 22 illustrates minimum and maximum average linear gain for the DAB frequencies shown in FIGS. 23 through 26. FIG. 23 illustrates radiation patterns measured at frequencies of 174 MHz, 180 MHz, and 186 MHz. FIG. 24 illustrates radiation patterns measured at frequencies of 192 MHz, 198 MHz, and 204 MHz. FIG. 25 illustrates radiation patters measured at 210 MHz, 216 MHz, and 222 MHz. FIG. 26 illustrates radiation patters measured at 228 MHz, 234 MHz, and 240 MHz. Generally, the radiation patterns indicate that the AM/FM/DAB antenna 108 has good unidirectional performance at these frequencies.

In some exemplary embodiments, a multiband vehicular shark fin antenna assembly includes only a single AM/FM/DAB antenna (e.g., AM/FM/DAB antenna 108, etc.) without any other antennas. In other exemplary embodiments, a multiband vehicular shark fin antenna assembly (e.g., 100, etc.) includes the AM/FM/DAB antenna 108 in addition to one or more other antennas (e.g., 114, 118, etc.). Examples of other antennas includes satellite navigation antennas (e.g., GPS patch antenna, GLONASS patch antenna, etc.) and/or SDARS antennas (e.g., SDARS patch antenna, etc.). In some embodiments, a satellite navigation patch antenna may be stacked on top of or positioned adjacent or side-by side with a SDARS patch antenna.

By way of further example, exemplary embodiments of antenna assemblies may be configured for use as multiband multiple input multiple output (MIMO) antenna assemblies operable in the AM/FM/DAB frequency bands via an antenna (e.g., 108, etc.) disclosed herein and operable in one or more other frequency bands associated with, e.g., cellular communications, Wi-Fi, DSRC (Dedicated Short Range Communication), satellite signals, terrestrial signals, etc. For example, exemplary embodiments of antenna assemblies may be operable in the AM, FM, and DAB-III frequency bands, and one or more or any combination (or all) of the following frequency bands: DAB-L, GNSS, global positioning system (GPS), global navigation satellite system (GLONASS), Doppler Orbitography and Radio-positioning Integrated by Satellite (DORIS), BeiDou Navigation Satellite System (BDS), satellite digital audio radio services (SDARS) (e.g., Sirius XM Satellite Radio, etc.), AMPS, GSM850, GSM900, PCS, GSM1800, GSM1900, AWS, UMTS, digital audio broadcasting (DAB)-VHF-III, DAB-L, Long Term Evolution (e.g., 4G, 3G, other LTE generation, B17 (LTE), LTE (700 MHz), etc.), Wi-Fi, Wi-Max, PCS, EBS (Educational Broadband Services), BRS (Broadband Radio Services), WCS (Broadband Wireless Communication Services/Internet Services), cellular frequency bandwidth(s) associated with or unique to a particular one or more geographic regions or countries, one or more frequency bandwidth(s) from Table 2 and/or Table 3 below, etc.

TABLE 2

| | Upper Frequency | Lower Frequency |
|---|---|---|
| System/Band Description | (MHz) | (MHz) |
| 700 MHz Band | 698 | 862 |
| B17 (LTE) | 704 | 787 |
| AMPS/GSM850 | 824 | 894 |
| GSM 900 (E-GSM) | 880 | 960 |
| DCS 1800/GSM1800 | 1710 | 1880 |
| PCS/GSM1900 | 1850 | 1990 |
| W CD MA/UMTS | 1920 | 2170 |
| 2.3 GHz Band IMT Extension | 2300 | 2400 |
| IEEE 802.11B/G | 2400 | 2500 |
| EBS/BRS | 2496 | 2690 |
| WiIMAX MMDS | 2500 | 2690 |
| BROADBAND RADIO | 2700 | 2900 |
| SERVICES/BRS (MMDS) | | |
| W IMAX (3.5 GHz) | 3400 | 3600 |
| PUBLIC SAFETY RADIO | 4940 | 4990 |

TABLE 3

| | Tx/Uplink (MHz) | | Rx/Downlink (MHz) | |
|---|---|---|---|---|
| Band | Start | Stop | Start | Stop |
| GSM 850/AMPS | 824.00 | 849.00 | 869.00 | 894.00 |
| GSM 900 | 888.00 | 914.80 | 915.40 | 959.80 |
| AWS | 1710.00 | 1755.80 | 2214.00 | 2180.00 |
| GSM 1800 | 1710.20 | 1784.80 | 1805.20 | 1879.80 |
| GSM 1900 | 1850.00 | 1910.00 | 1930.00 | 1990.00 |
| UMTS | 1920.00 | 1980.00 | 2110.00 | 2170.00 |
| LTE | 2010.00 | 2025.00 | 2010.00 | 2025.00 |
| LTE | 2300.00 | 2400.00 | 2300.00 | 2400.00 |
| LTE | 2496.00 | 2690.00 | 2496.00 | 2690.00 |
| LTE | 2545.00 | 2575.00 | 2545.00 | 2575.00 |
| LTE | 2570.00 | 2620.00 | 2570.00 | 2620.00 |

Accordingly, exemplary embodiments are disclosed herein of multiband vehicular antenna assemblies that may provide one or more (but not necessarily any or all) of the following advantages or benefits as compared to some existing multiband vehicular antenna assemblies. For example, exemplary embodiments may have a better appearance or styling (e.g., an aesthetically pleasing, aerodynamic shark-fin configuration, etc.) and/or may be compact or smaller in size and shape. Exemplary embodiments may have good electrical performance, such as shown in FIGS. 11 through 26. In exemplary embodiments, the AM/FM/DAB antenna may be a relatively low cost part and/or that may be manufactured via a relatively low cost and not overly complicated process.

In addition, various antenna assemblies (e.g., 100, etc.) disclosed herein may be mounted to a wide range of supporting structures, including stationary platforms and mobile platforms. For example, an antenna assembly (e.g., 100, etc.) disclosed herein could be mounted to supporting structure of a bus, train, aircraft, bicycle, motor cycle, boat, among other mobile platforms. Accordingly, the specific references to motor vehicles or automobiles herein should not be construed as limiting the scope of the present disclosure to any specific type of supporting structure or environment.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally,” “about,” and “substantially,” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A shark fin antenna assembly for installation to a vehicle body wall, the shark fin antenna assembly comprising:
a chassis;
a radome having a shark-fin configuration, the radome coupled to the chassis such that an interior enclosure is collectively defined by the radome and the chassis; and
a first antenna within the interior enclosure, the first antenna comprising electrical conductors along first and second sides of the first antenna that are interconnected to thereby define an electrical path extending around at least part of the first antenna, whereby the first antenna is configured to be operable within multiple frequency bands including AM (amplitude modulation), FM (frequency modulation), and DAB-III (digital audio broadcasting) frequency bands.

2. The shark fin antenna assembly of claim 1, wherein the electrical conductors along the first side are operable with the electrical conductors along the second side as a singular resonant structure for AM, FM, and DAB-III frequencies.

3. The shark fin antenna assembly of claim 1, wherein:
the first antenna comprises an inductor and a capacitor in series with the inductor;
the inductor and the capacitor are electrically connected with the electrical conductors;
whereby the inductor and the capacitor are operable for shorting portions of the electrical conductors such that:
the first antenna is operable in the AM frequency band and the FM frequency band when the electrical conductors are not shorted by the inductor and the capacitor; and
the first antenna is operable in the DAB-III frequency band when the portions of the electrical conductors are shorted by the inductor and the capacitor.

4. The shark fin antenna assembly of claim 1, wherein:
the electrical conductors define a loading coil having a plurality of turns;
the first antenna comprises an inductor and a capacitor in series with the inductor;
the inductor and the capacitor are electrically connected with the electrical conductors;
whereby the inductor and the capacitor are operable for shorting one or more turns or portions thereof of the loading coil such that the first antenna is operable as a singular resonant structure with a primary resonance from 76 megahertz to 108 megahertz when the one or more turns or portions thereof of the loading coil are not shorted by the inductor and the capacitor, and with a secondary resonance from 174 megahertz to 240 megahertz when the one or more turns or portions thereof of the loading coil are shorted by the inductor and the capacitor.

5. The shark fin antenna assembly of claim 1, wherein the electrical conductors along the first side are interconnected with the electrical conductors along the second side such that the electrical path defined by the electrical conductors is continuous and coils around the at least part of the first antenna to thereby define an inductively loaded coil of the first antenna.

6. The shark fin antenna assembly of claim 1, wherein the electrical conductors along the first side are collectively operable with the electrical conductors along the second side to thereby provide a singular resonant structure having multiple resonances including from 76 megahertz to 108 megahertz when all of the electrical conductors are used, and from 174 megahertz to 240 megahertz when less than all of the electrical conductors are used and a portion of the electrical conductors are shorted.

7. The shark fin antenna assembly of claim 1, wherein the first antenna comprises:
a printed circuit board having a first side and an opposing second side; and
the electrical conductors comprise traces along the first and second sides of the printed circuit board.

8. The shark fin antenna assembly of claim 7, wherein:
the traces along the first side comprise five generally straight, horizontal, and parallel traces, including an upper trace connected by a bending portion to an electrically-conductive element along an upper portion of the printed circuit board; and
the traces along the second side comprise five generally straight, parallel, and upwardly angled traces, including a lower trace electrically connected to a vertical trace that extends downwardly along the second side for electrically connecting the traces to a second printed circuit board.

9. The shark fin antenna assembly of claim 7, wherein:
the electrical conductors define an inductively loaded portion of the first antenna; and
the first antenna further comprises a capacitively loaded portion along an upper portion of the printed circuit board.

10. The shark fin antenna assembly of claim 9, wherein:
the first antenna comprises first and second electrically-conductive elements along the respective first and second sides of the printed circuit board that define the capacitively loaded portion of the first antenna;
an electrically-conductive insert is positioned within the radome; and
an electrically-conductive clip is coupled to the upper portion of the printed circuit board for establishing electrical contact between the first antenna and the insert, whereby the insert operates to form a capacitive load portion of the first antenna; and
the shark fin antenna assembly is configured to be installed and fixedly mounted to a vehicle body wall after being inserted into a mounting hole in the vehicle body wall from an external side of the vehicle and nipped from the interior compartment side.

11. The shark fin antenna assembly of claim 1,
the first antenna is a vertical monopole antenna configured for use with AM, FM, and DAB-III frequencies; and
the shark fin antenna assembly further comprises at least one antenna within the interior enclosure and operable within one or more frequency bands different than AM/FM/DAB-III bands.

12. The shark fin antenna assembly of claim 1, further comprising:
a second antenna within the interior enclosure and configured to be operable with satellite navigation signals; and/or
a third antenna within the interior enclosure and configured to be operable with cellular signals; and/or
a fourth antenna within the interior enclosure and configured to be operable with DAB-L signals.

13. An antenna assembly for installation to a vehicle body wall, the antenna assembly comprising a first antenna including a printed circuit board and electrical conductors along first and second sides of the printed circuit board, wherein the electrical conductors along the first side are interconnected with the electrical conductors along the second side to thereby define an electrical path around at least part of the printed circuit board, whereby the first antenna is configured to be operable with at least a first frequency band, a second frequency band higher than the first frequency band, and a third frequency band higher than the second frequency band.

14. The antenna assembly of claim 13, wherein the electrical conductors along the first side are operable with the electrical conductors along the second side as a singular resonant structure having multiple resonances including from 76 megahertz to 108 megahertz and from 174 megahertz to 240 megahertz.

15. The antenna assembly of claim 13, wherein the electrical conductors along the first and second sides are operable to thereby provide a singular resonant structure having multiple resonances including:
a primary resonance for frequencies within the first and second frequency bands from all of the electrical conductors; and
a secondary resonance for frequencies within the third frequency band from less than all of the electrical conductors when a portion of the electrical conductors are shorted.

16. The antenna assembly of claim 13, wherein:
the first antenna comprises an inductor and a capacitor in series with the inductor;
the inductor and the capacitor are electrically connected with the electrical conductors;
whereby the inductor and the capacitor are operable for shorting portions of the electrical conductors such that:
the first antenna is operable in the first and second frequency bands when the electrical conductors are not shorted by the inductor and the capacitor; and
the first antenna is operable in the third frequency band when the portions of the electrical conductors are shorted by the inductor and the capacitor.

17. The antenna assembly of claim 13, wherein:
the electrical conductors define a loading coil having a plurality of turns;
the first antenna comprises an inductor and a capacitor in series with the inductor;
the inductor and the capacitor are electrically connected with the electrical conductors;
the inductor and the capacitor are operable for shorting one or more turns or portions thereof of the loading coil;
the first antenna is operable in the first frequency band from 535 kilohertz to 1605 kilohertz and the second frequency band from 76 megahertz to 108 megahertz when the one or more turns or portions thereof of the loading coil are not shorted by the inductor and the capacitor; and
the first antenna is operable in the third frequency band from 174 megahertz to 240 megahertz when the one or more turns or portions thereof of the loading coil are shorted by the inductor and the capacitor.

18. The antenna assembly of claim 13, further comprising:
a chassis;
a radome coupled to the chassis such that an interior enclosure is collectively defined by the radome and the chassis;
a second antenna within the interior enclosure and configured to be operable with satellite navigation signals;
a third antenna within the interior enclosure and configured to be operable with cellular signals;
wherein the first antenna is within the interior enclosure; and
wherein the first frequency band includes AM frequencies from 535 kilohertz to 1605 kilohertz, the second frequency band includes FM frequencies from 76 megahertz to 108 megahertz, and the third frequency band includes DAB-III frequencies from 174 megahertz to 240 megahertz.

19. An antenna comprising:
a printed circuit board;
electrical conductors along first and second sides of the printed circuit board, wherein the electrical conductors along the first side are interconnected with the electrical conductors along the second side to thereby define a continuous electrical path coiling around at least part of the printed circuit board;
an inductor and a capacitor in series with the inductor, the inductor and the capacitor are electrically connected with the electrical conductors;
whereby the inductor and the capacitor are operable for shorting portions of the electrical conductors such that:
the antenna is operable in at least a first frequency band and a second frequency band that is higher than the first frequency band when the electrical conductors are not shorted by the inductor and the capacitor; and
the antenna is operable in at least a third frequency band that is higher than the second frequency band when the portions of the electrical conductors are shorted by the inductor and the capacitor.

20. The antenna of claim 19, wherein:
the electrical conductors define a loading coil having a plurality of turns;
the inductor and the capacitor are operable for shorting one or more turns or portions thereof of the loading coil;
whereby the antenna is operable in at least the first frequency band including AM frequencies from 535 kilohertz to 1605 kilohertz and the second frequency band including FM frequencies from 76 megahertz to 108 megahertz when the one or more turns or portions thereof of the loading coil are not shorted by the inductor and the capacitor; and/or
whereby the antenna is operable in at least the third frequency band including DAB-III frequencies from 174 megahertz to 240 megahertz when the one or more turns or portions thereof of the loading coil are shorted by the inductor and the capacitor; and/or
whereby the antenna is operable as a singular resonant structure having a primary resonance from 76 megahertz to 108 megahertz when the one or more turns or portions thereof of the loading coil are not shorted by the inductor and the capacitor, and a secondary resonance from 174 megahertz to 240 megahertz when the one or more turns or portions thereof of the loading coil are shorted by the inductor and the capacitor.
